(19) United States
(12) Patent Application Publication
(10) Pub. No.: US 2005/0028508 A1
(43) Pub. Date: Feb. 10, 2005

(54) Picking accessory for berry harvester

(76) Inventor: Roderick Komar, Marstons Mills, MA (US)

Correspondence Address: Thomas Kahrl, Box 1177, West Falmouth, MA, 02574, US

(21) Appl. No.: 10/721,486

(22) Filed: Nov. 25, 2003

Related U.S. Application Data
(60) Provisional application No. 60/429,472, filed on Nov. 26, 2002.

(51) Int. Cl. A01D 46/00

(52) U.S. Cl. 56/330

(57) ABSTRACT

An improved self propelled fruit or berry harvester suitable to pick berries which grow on a low bush or vine, such as cranberries. Typically the vines are stripped of fruit by a picking head wherein said fruit is are carried by a conveyor and heretofore typically loaded into storage bags mounted on the harvester for further transfer to shipping bins. The improvement is directed to a picking accessory comprising an accessory conveyor for loading stripped fruit directly into an associated collection bin employed as a shipping container.

This is a complete “Non-Provisional” Patent Application which is filed less than 12 months from the filing date of a “Provisional” application, which was filed Nov. 26, 2003.

### BACKGROUND OF THE INVENTION

1. Field of the Invention (Technical Field)

This invention relates to an improved self propelled fruit or berry harvester suitable to pick berries which grow on a low bush or vine, such as cranberries. Typically the vines are stripped of fruit by a picking head wherein said fruit is are carried by a conveyor and heretofore typically loaded into storage bags mounted on the harvester for further transfer to shipping bins. The improvement is directed to a picking accessory comprising an accessory conveyor for loading stripped fruit directly into an associated self propelled collection bin configured to be employed as a shipping container.

2. Prior Art

Originally cranberries were harvested manually by means of scoops or shovels. These are essentially a shovel with an array of teeth or spikes at the outer end. In operation the scoop is thrust into the vines below the fruit and agitated manually whereby the fruit is broken free and falls into the scoop. Thereafter the cranberries contained in the scoop are manually poured into a container, typically a wooden cranberry box. More recently a variety of mechanized cranberry pickers are discussed in a publication entitled “Fresh Fruit Harvesting and Handling Project, Ocean Spray Cranberries, Inc.” by H. Willett & Associates, of Jeanerette, La., September 1989. These pickers had a fruit picking head, conveyor(s), and a storage hopper or bin on the machine.

Other fruit pickers are shown in the following prior art patents U.S. Pat. No. 1,354,283 (Clapp) issued Sep. 28, 1920 discloses a cranberry picker in which picking fingers perform a rocking movement and cranberry collecting scoops travel, driven by chains, in a direction opposite to the pointing direction of the fingers for collecting the berries from the fingers. The frame which carries the rocking fingers and the traveling scoops is adjustable into several fixed positions to determine the clearance between the ground on which the picker travels and the picking fingers. The picking fingers are not capable of automatically responding to obstacles on the ground.

U.S. Pat. No. 1,371,306 (Hayden) issued Mar. 15, 1921, discloses a cranberry harvester in which again berry stripping scoops cooperate with picker units for gathering the berries from the scoops. The picker units travel in the same direction as the stripping scoops. Therefore, the spillage of picked berries must be substantial. A manually operable linkage system including toggle links enables the operator to raise the picking components to clear obstructions on the ground. An automatic response to obstacles on the ground is not disclosed in the Hayden cranberry picker.

U.S. Pat. No. 1,622,117 (Jenkins) issued Mar. 22, 1927, discloses a berry picker quite similar to that of U.S. Pat. No. 1,193,189 (Richter). In Jenkins a berry picking drum carries berry picking tines which are supposed to collect the berries onto a chute which is stationary inside the drum for lateral discharge of the berries. The picking unit is secured to one end of a frame, the other end of which is handled by an operator. The frame is secured to the axle of a pair of support wheels for permitting a see saw type of movement. In other words, the operator can raise or lower the picking unit to the extent permitted by a position adjustable ground engaging wheel secured to the forward end of the seesaw frame. An automatic response to ground obstacles for raising and lowering of the picking unit is not possible in the Jenkins picker.

As is shown above the above noted various embodiments of berry harvesters. The combination of a picking accessory in association with a mobile chassis are known.

### DESCRIPTION OF THE INVENTION

In the present improved berry harvester there is included a picking accessory in association with a mobile chassis having front and rear ends, included is a self contained power unit, an axial conveyor and a picking head suitable to pick berries which grow on a vine, such as cranberries. In operation the vines are stripped of fruit which are deposited on and thereafter carried by an axial conveyor extending longitudinally of the chassis to the rear of the chassis and heretofore typically loaded into storage bags mounted on the rear end of the chassis, for further transfer to shipping bins. The improvement is directed to the combination of a picking accessory comprising an accessory transverse conveyor for attachment to the rear of the chassis for accepting fruit from the berry harvester and loading stripped fruit directly into an associated accessory collection bin, that is also self powered to operate in tandem with the berry harvester.

The picking accessory comprises a conveyor consisting of an endless belt supported intermediate a right angle drive means and a discharge sprocket means said endless belt having transverse self means comprising flights for carrying berry portions deposited there on.

Preferably the transverse conveyor means comprises an endless berry conveyor means operatively mounted in orthogonal relationship to the axial conveyor, whereby said accessory endless berry conveyor extend substantially perpendicular to the travel direction with the accessory collection bin arranged to receive from said second endless berry conveyor means for transporting berries in a collection shipping container towed behind said mobile support means.

The transverse flights comprising at least 16 in number are conveniently fixedly attached to the endless belt means comprising molded plastic segments, each of which are may be rotatably interconnected by pins attached, said belt means mounted on the right angle drive means, the right angle drive means including the power take off means connected to shaft means driven by the motor mean.

The chassis is conveniently self propelled.

ADVANTAGES OF PICKING ACCESSORY; There are three distinct advantages of the picking accessory.
1. Labor savings.
2. Increased efficiency
3. Delivering better quality fruit.
   Labor Savings:

The current process of picking and moving the fruit is a five step processes. First the fruit is stripped off the vine by a picking machine and delivered to a burlap bag. Second the bag is then picked up by the operator and set on the cranberry bog. Third the bag is then picked up by a person and stacked on a self propelled cart. Fourth the cart is then driven off the bog where the bags are then picked up by a person and emptied into a shipping bin. Fifth the bin is then mechanically picked up and put on a truck for delivery.

With the picking accessory several of these steps are eliminated. First the fruit is stripped off the vine by the picking machine and delivered via the accessory conveyor directly to the accessory collection bin. Second said bin is then mechanically delivered off the bog where third it is put on a truck for delivery. There is no physical handling of the fruit.

Increased Efficiency:

Each shipping bin holds six to eight bags of picked fruit. By picking directly into the bin the operator can now pick for a longer period of time without having to stop. The need for bags has been eliminated.

Fruit Quality:

Fruit being picked and delivered using the accessory is of higher quality due to less bruising for the following reasons. First just by eliminating handling steps there is less damage to the fruit. Second the fruit being picked is delivered evenly and with no excess force to the bin. Finally the bags of fruit are heavy (approx. 50 lbs), by eliminating human handling, stacking and emptying of the bags less bruising is incurred.

The present invention overcomes the limitations of the prior technology expressed above by providing for a self propelled fruit or berry harvester wherein fruit is carried successively by a main conveyor, then by an accessory conveyor to provide for loading the stripped fruit comprising cranberries directly into an associated shipping bin which overcomes at least some of the disadvantages of prior art.

### SUMMARY OF THE INVENTION

The invention is directed to an improved berry harvester including a picking head for stripping fruit supported on a mobile chassis moveable in a travel direction including an axial endless conveyor means having a berry receiving end and a berry depositing end, the improvement comprising an “accessory conveyor” attachable to said harvester for receiving fruit from the axial conveyor of the berry harvester and thereafter loading the fruit comprising cranberries into an associated self powered accessory bin configured for use as a shipping container.

The invention is directed to the improvement of adding a picking accessory to a berry harvester including a mobile chassis having front and rear ends, a self contained power unit, and a picking head. In operation, the vines are stripped of fruit which are deposited on and thereafter carried by an axial conveyor extending longitudinally of the chassis to the rear of the chassis and heretofore typically loaded into storage bags mounted on the rear end of the chassis. The berry harvester is arranged to be able to shift between a right hand pick position and a left hand pick position during picking of fruit responsive to the arrangement of the fruit vines. The improvement is directed to transverse conveyor for receiving fruit from the axial conveyor of the berry harvester and thereafter loading the stripped fruit comprising cranberries into an associated self powered accessory bin. In the present invention the accessory transverse conveyor which is arrayed transversely to the axial conveyor of the berry harvester is moveable between a right hand pick position and a left hand pick position during picking of fruit.

A critical feature of the novel transverse conveyor is that it may be selectively arrayed transversely to the axial conveyor, either in a right hand pick position and a left hand pick position in association with the direction of the fruit vines. The transverse conveyor is driven by a power take off means connected to the self contained power unit mounted on the chassis.

The associated collection bin includes a mobile frame having front and rear ends, and a self contained power unit for operating adjacent to the chassis of the berry harvester, positioned to receive the fruit from the transverse conveyor. In operation, the associated collection bin is positioned outboard of the axis of the chassis being arrayed just below the outboard end roller as close as possible, without actual contact operation. In practice this distance is preferably about 28 inches at the highest point of the end roller during operation.

It is a general object of the present invention to provide for an accessory picker to provide for labor savings in the process of picking and moving the fruit during harvest.

It is a another object of the present invention to provide for increased efficiency in the process of picking and moving the fruit during harvest.

It is a further object of the present invention to provide for delivering better quality fruit in the process of picking and moving the fruit during harvest.

Another object of the invention is to provide an accessory transverse conveyor which is arrayed transversely to the axial conveyor of a berry harvester that and is moveable between a right hand pick position and a left hand pick position during picking of fruit.

These and other objects, advantages, and features of the invention will be apparent from the following description of preferred embodiments considered along with the accompanying drawings.

The invention will be described for the purposes of illustration only in connection with certain embodiments; however, it is recognized that those persons skilled in the art may make various changes, modifications, improvements and additions on the illustrated embodiments all without departing from the spirit and scope of the invention.

### BRIEF DESCRIPTION OF THE DRAWINGS

The accompanying drawings, which are incorporated into and form a part of the specification, illustrate several embodiments of the present invention and together with the description serve to explain the principals of the invention. The drawings are only for the purpose of illustrating a preferred embodiment of the invention and are not construed as limiting the invention

FIG. 1 shows a front view of the preferred embodiment of the present invention mounted on a berry harvester in the Left Hand Pick position, shown in association with an associated collection bin.

FIG. 2 shows a schematic rear view of the berry harvester with the transverse conveyor of the preferred embodiment of FIG. 1 in the Right Hand Pick position powered by the berry harvester power pulley in combination with the self powered collection bin.

FIG. 3 shows a schematic rear view of the berry harvester with the transverse conveyor of the preferred embodiment of FIG. 1 in the Left Hand Pick position powered by the berry harvester power pulley, in combination with the self powered collection bin.

FIG. 4 shows a side view of the power take off of the preferred embodiment of FIG. 1 as connected to a berry harvester shown in the Right Hand Pick position.

FIG. 5 shows a side view of the preferred embodiment of FIG. 1 as connected to a berry harvester shown in the Right Hand Pick position shown picking cranberries which are carried by the transverse conveyor.

FIG. 6 shows a detailed side view of the power takeoff of the preferred embodiment of FIG. 1

FIG. 7 shows a detailed top view of the power takeoff of the preferred embodiment of FIG. 1

FIG. 8 shows an exploded detailed view of the power takeoff of the preferred embodiment of FIG. 1

FIG. 9 shows a perspective view of a storage bag hung from the rear of a prior art berry harvester.

### DETAILED DESCRIPTION OF THE PREFERRED EMBODIMENT

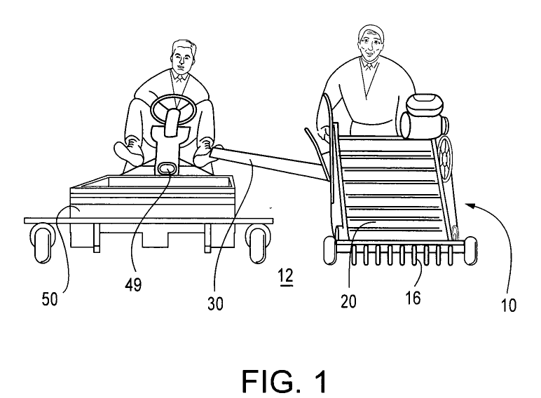

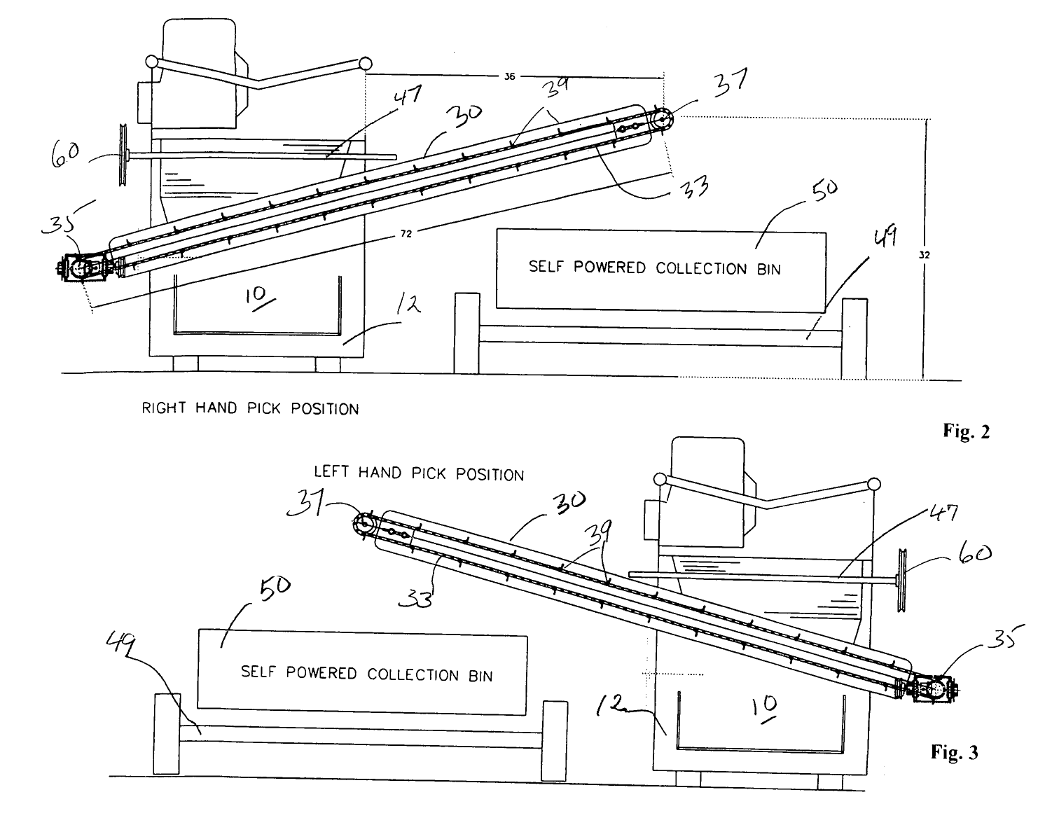

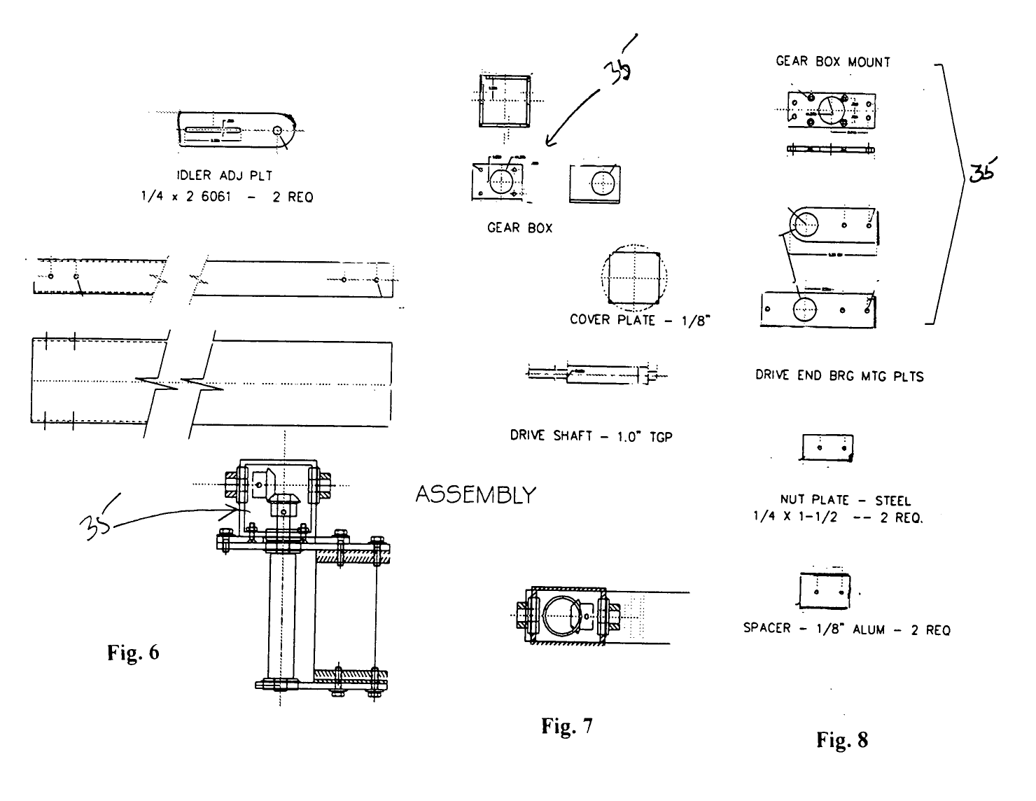

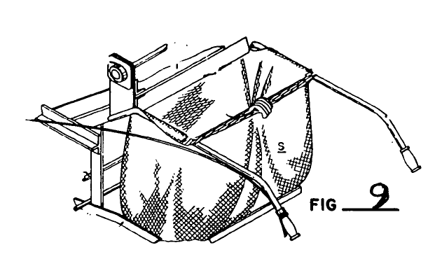

Referring to the FIGS. 1-8, the preferred embodiment is directed to the inventive improvement of a prior art berry harvester 10, as is shown in FIG. 1, including a mobile chassis 12 having front and rear ends, a self contained power unit 14, and a picking head 16 suitable to pick fruit 15, comprising cranberries as displayed on transverse conveyor in FIG. 5. As the cranberries are picked, the fruit is deposited on and thereafter carried by an axial conveyor 20 extending longitudinally of the chassis 12 to the rear of said chassis and deposited on the preferred embodiment of the present invention comprising accessory transverse conveyor 30 mounted on the rear end of the chassis 12. Mounting is selectively in the right hand picking position as shown in FIG. 2, or in the left hand picking position as shown in FIG. 3.

Referring to FIGS. 2-5 the preferred embodiment is directed to the combination of an associated accessory collection bin 50 and an accessory transverse conveyor 30 for loading the stripped fruit 15 comprising cranberries into said accessory bin 50. Said accessory conveyor 30, as is shown in FIGS. 1-5, is arrayed transversely to the axial conveyor 20 , and is rotatably mounted on the chassis 12 moveable between a right hand pick position and a left hand pick position. The accessory transverse conveyor 30 is driven by a power take off 32 connected to the power pulley 60 of self contained power unit 14 mounted on the chassis 12.

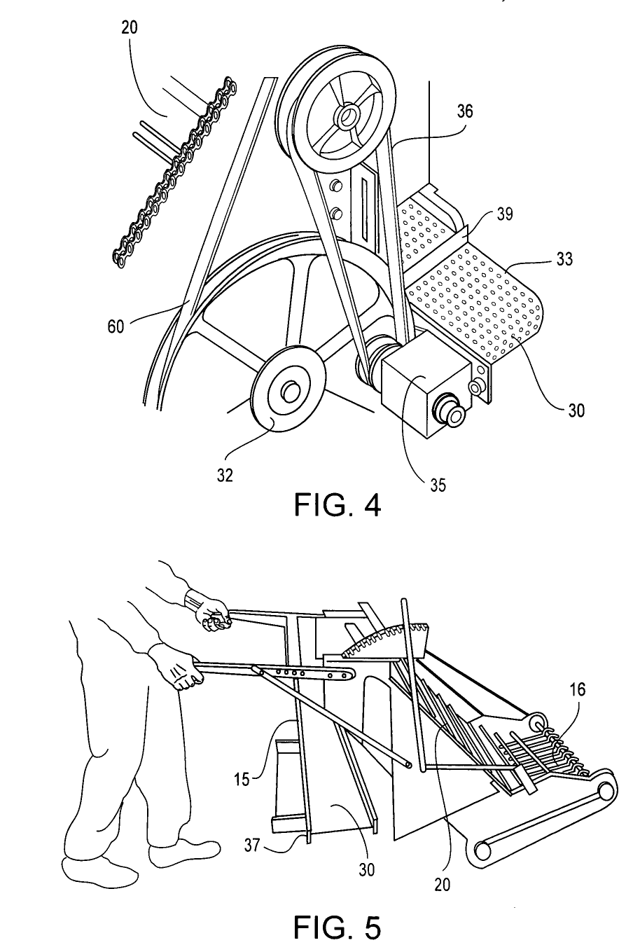

The accessory conveyor comprises an endless belt 33 supported between a right angle drive means 35 and discharge sprocket 37 said endless belt having transverse flights 39 for carrying berry portions. The right angle drive means is connected by a belt 36 to main drive power pulley 60, as shown in FIG. 4.

The self propelled, accessory collection bin 50 is operated in association with the rear of the chassis 12 positioned to receive the berries 15 from the transverse conveyor 30, being arrayed just below the outboard end of discharge sprocket 37 as close as possible, without actual contact operation. In practice this distance is preferably about 32 inches at the highest point of the end roller during operation.

Preferably the transverse conveyor 30 comprises an endless berry conveyor belt 33 operatively mounted in orthogonal relationship to the axial conveyor 20, whereby said accessory transverse conveyor 30 extend substantially perpendicular to the travel direction of the berry harvester 10 with the accessory collection bin 50 arranged to receive from said second endless berry conveyor means for transporting berries 15 in a collection container 50 towed behind the mobile chassis 12.

The transverse flights 39 are conveniently fixedly attached to the endless belt 33 comprising rigid molded plastic segments 41, each of which are rotatably interconnected by pins 43 attached thereto, said belt 33 mounted on the right angle drive 35. The right angle drive 35 including the power take off 45 is connected to shaft 47 driven by power unit 14.

As is shown in FIGS. 2-4 the transverse conveyor 30 powered by the berry harvester power pulley 60 can be mounted in either the right hand or left hand position as is shown in FIGS. 2 & 3.

FIG. 4 shows a schematic rear view of the berry harvester 10 with the transverse accessory conveyor 30 of the preferred embodiment of FIG. 1 in the Left Hand Pick position powered by the berry harvester power pulley 60.

Chassis 49 of collection bin 50 is conveniently self propelled as is shown in FIG. 1.

1. In a fruit harvester including a picking head for stripping fruit supported on a mobile chassis moveable in a travel direction including an axial endless conveyor means powered by a main drive power pulley, having a berry receiving end and a berry depositing end, the improvement comprising an picking accessory comprising a conveyor in combination with a accessory bin wherein the conveyor is mounted on said harvester for receiving fruit from the axial conveyor of the berry harvester and thereafter conveying the fruit for loading in the accessory bin.

2. The fruit harvester of claim 1 wherein the conveyor is arrayed as a transverse conveyor positioned transversely in orthogonal relationship to the axial conveyor of the berry harvester and is moveable between a right hand pick position and a left hand pick position to the picking head during picking of fruit.

3. The fruit harvester of claim 2 wherein the transverse conveyor has an inboard end attached to the fruit harvester and an outboard end cantilevered over the associated accessory bin, comprising a self powered accessory bin.

4. The fruit harvester of claim 3 wherein the transverse conveyor comprises;
a) a frame having a right angle drive means at one end and a discharge sprocket at the other;
b) a cantilever attachment means for connecting the transverse conveyor to the fruit harvester in a cantilever mode; and
c) an endless belt supported between the right angle drive means and the discharge sprocket, said endless belt having transverse flight members for carrying berry portions comprising cranberries. wherein the right angle drive means is connected by a belt to a main drive power pulley of the fruit harvester.

5. The fruit harvester of claim 1 wherein the self propelled collection bin is operated in tandem in association with the rear of the fruit harvester chassis positioned to receive the berries from an outboard end of the transverse conveyor, being arrayed just below the outboard sprocket as close as possible, without actual contact operation.

6. The fruit harvester of claim 5 wherein this distance is preferably about 32 inches at the highest point of the end roller during operation.

7. The fruit harvester of claim 1 wherein the transverse conveyor is powered by the fruit harvester power pulley which can be mounted in either the right hand or left hand position to accommodate changes in travel direction.

8. The fruit harvester of claim 1 wherein flight members of the transverse conveyor are conveniently fixedly attached to the endless belt means for controlling movement of berries comprising rigid molded plastic segments, each of which are may be rotatably interconnected by pins attached, said belt means mounted on the right angle drive means.

9. A method of “dry picking” cranberries in combination with packing the fruit in situ in shipping containers comprising the steps of;
providing cranberry vines in a dry condition where grown in a cranberry “bog”;
stripping fruit from cranberries vines by operation of a picking head of a fruit harvester wherein fruit is carried successively by a main conveyor, then by an accessory conveyor to provide for loading the stripped fruit comprising cranberries directly into an associated shipping bin said bin is then mechanically delivered off the bog where third it is put on a truck for delivery,

10. The method of claim 9 fruit being picked and delivered using the accessory bin is of higher quality due to less bruising due to firstly by eliminating handling steps there is less damage to the fruit, secondly the fruit being picked is delivered evenly and with no excess force to the bin and finally the bags of fruit are heavy (approx. 50 lbs), by eliminating human handling, stacking and emptying of the bags less bruising is incurred.
